(19) United States
(12) Patent Application Publication
(10) Pub. No.: US 2006/0056010 A1
(43) Pub. Date: Mar. 16, 2006

(54) Compact AOM transducer array for use with phase shift imaging

(75) Inventor: Paul C. Allen, Beaverton, OR (US)

Correspondence Address: PATENT COUNSEL;APPLIED MATERIALS, INC., Legal Affairs Department, P.O. BOX 450A, Santa Clara, CA, 95052, US

(73) Assignee: Applied Materials,Inc.

(21) Appl. No.: 11/003,042

(22) Filed: Dec. 3, 2004

Related U.S. Application Data
(60) Provisional application No. 60/609,560, filed on Sep. 13, 2004.

(51) Int. Cl. G02F 1/33

(52) U.S. Cl. 359/305

(57) ABSTRACT

A method of illuminating a surface of a substrate, the method involving: generating an array of separately modulated beams, wherein on each beam of the array of separately modulated beams, a corresponding modulation signal is imposed that propagates transversely across that beam from a bottom edge to a top edge at a velocity V; projecting the array of separately modulated beams onto the surface of the substrate, wherein the array of beams illuminates on the surface of the substrate a two-dimensional region having a width determined by the number of beams in the array and a height that extends multiple pixels; causing the illuminated region to scan over the surface of the substrate in a scan direction relative to the substrate and at a scan velocity determined by V, wherein the illumination over the illuminated varies in phase in both the scan direction and in a direction that is orthogonal to the scan direction.

This application claims the benefit of U.S. Provisional Application No. 60/609,560, filed Sep. 13, 2004.

### TECHNICAL FIELD

This invention relates to acousto-optic modulators (AOMs) and to direct writing systems that use AOMs.

### BACKGROUND OF THE INVENTION

Increased design time and the affordability of masks are widely acknowledged to be limitations on the continuing progress of the semiconductor industry. Substantial time and expense are often required to implement resolution enhancing features into new silicon designs. Low volume and customized semiconductor designs may need to amortize mask costs over only a few tens or hundreds of wafers. Resolution enhancing techniques, pattern complexity and tighter specifications are increasing design time, lowering mask yield, increasing mask write times and raising the cost of masks. For example, a typical cycle time for an advanced mask is 14 days. For these reasons IC designers, custom IC manufactures and foundries have renewed their interest in a direct write solution.

A powerful benefit of a direct write solution is the implementation of process feedback into the lithography loop. For instance metrology might indicate a certain pattern of etch non-uniformity subsequent to patterning that may change over the time between preventive maintenance on the etcher. This information could be used to precompensate feature sizes in the effected parts of the wafer during the pattern writing, thereby improving yield and device performance. Additionally, elimination of the mask writing step allows an estimated 86% of the CD control budget for a direct write system as opposed to 70% of the CD control budget for a combined wafer lithography system.

Advanced development groups such as the consortium of Motorolla, Phillips and STMicro in Crolles, France have experimented with e-beam direct write to shorten development time. E-beam solutions have, however, proven to be slow and subject to process difficulties from alignment mark detection and proximity effects due to electron backscattering from the layers below the resist.

So far, optical architectures have been unable to compete directly with the capabilities of steppers in the arena of resolution enhancing technologies (RET). The direct write solution is only attractive if it is capable of replacing the most demanding and therefore the most costly mask layers. But the technologies developed thus far have been unable to compete as an effective mask writer.

What is needed is a fast, simple optical architecture capable of using the same RET techniques available to steppers.

### SUMMARY OF THE INVENTION

In general, in one aspect, the invention features a phase shift pattern generator architecture that fulfills the requirements described above. It includes a new multi-channel acousto-optic modulator that is capable of phase as well as amplitude modulation.

In general, in another aspect, the invention features a method of illuminating a surface of a substrate. The method involves: generating an array of separately modulated beams, wherein on each beam of the array of separately modulated beams, a corresponding modulation signal is imposed that propagates transversely across that beam from a bottom edge to a top edge at a velocity V; projecting the array of separately modulated beams onto the surface of the substrate, wherein the array of beams illuminates on the surface of the substrate a two-dimensional region having a width determined by the number of beams in the array and a height that extends multiple pixels; and causing the illuminated region to scan over the surface of the substrate in a scan direction relative to the substrate and at a scan velocity determined by V, wherein the illumination over the illuminated varies in phase in both the scan direction and in a direction that is orthogonal to the scan direction.

Other embodiments include one or more of the following features. The scan velocity is selected so that a projection of the modulation signals onto the surface of the substrate remain fixed relative to the surface of the substrate. More specifically, the scan velocity is selected to satisfy the scophony condition. The illumination over the two dimensional region exhibits phase changes of 180° in both the scan direction and in the orthogonal direction. Causing the illuminated region to scan over the surface of the substrate involves moving the substrate while leaving the projected array of separately modulated beam to remain stationary. Causing the illuminated region to scan over the surface of the substrate involves scanning the projected array of beams. The generating the array of separately modulated beams involves generating a rectangularly-shaped beam and then passing the rectangularly-shaped beam through an acousto-optic modulator cell that includes a plurality of transducers on one end. Generating the array of separately modulated beams also involves driving each transducers of the plurality of transducers with corresponding modulated RF signal to impose the modulation signal on that beam. The array of separately modulated beams is a closely packed array of separately modulated beams.

In general, in still another aspect, the invention features a system for illuminating a substrate. The system includes: a source for generating a sheet beam; an acousto-optic modulator having a transducer array, the acousto-optic modulator during operation receiving the sheet beam from the source and generating an array of separately modulated beams therefrom; an optical system for projecting the array of separately modulated beams onto a surface of the substrate to illuminate a two-dimensional region on the substrate, the two-dimensional region having a width determined by the number of transducers in the array of transducers and a height that extends multiple pixels; a control system which during operation drives the array of transducers to impose on the array of beams a plurality of modulation signals which at the substrate propagate transversely across the illuminated region from a bottom edge of that region to a top edge of that region and at a velocity V; and a mechanism that during operation causes the illuminated region to scan over the surface of the substrate in a scan direction relative to the substrate and at a scan velocity determined by V, wherein the controller is programmed to cause the illumination over the illuminated region to vary in phase in both the scan direction and in a direction that is orthogonal to the scan direction.

Other embodiments have one or more of the following features. The scan velocity is selected so that a projection of the modulation signals onto the surface of the substrate remain fixed relative to the surface of the substrate. More specifically, the scan velocity is selected to satisfy the scophony condition. The illumination over the two dimensional region exhibits phase changes of 180° in both the scan direction and in the orthogonal direction. The mechanism includes a substrate holder and a transport system which controls a position of the substrate holder, and the controller causes the illuminated region to scan over the surface of the substrate by using the transport system to scan the substrate holder beneath the optical system, thereby moving the substrate while leaving the projected array of separately modulated beam stationary. Alternatively, the mechanism includes a revolving mirror that causes the projected array of beams to scan over surface of the substrate. The source for generating the sheet beam comprises a laser light source and a sheet beam generator. The sheet beam is a rectangularly-shaped beam. The controller includes a plurality of RF signal generators, each of which drives a different transducer of the array of transducers. The transducer array is a closely packed array of transducers. The transducers in the transducer array are nested with each other. Each transducer has an outer perimeter that is defined by an erf function.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 illustrates a basic system architecture.

FIG. 2 shows a single channel AOM with incident and diffracted laser beams.

FIG. 3 shows an AOM transducer geometry as viewed from the top of the transducer array.

FIG. 4a shows the diffracted intensity for individual transducers and for entire array energized.

FIG. 4b shows the diffracted intensity for the entire array energized.

FIG. 5 shows the result of driving the edge pixel with different gray levels and filtering the result with a finite lens NA.

FIG. 6a shows the intensity profile of an eight-transducer array with one beam turned off.

FIG. 6b shows the intensity profile of the eight-transducer array the first four transducers with a 0° signal and second four transducers energized with a 180° signal.

FIG. 7 shows edge sharpening by out-of-phase edge pixel.

FIG. 8 shows diffracted intensity for four pair of erf transducers.

FIGS. 9a and 9b show the real part of the electric field from alternating lines and vias, respectively

FIGS. 10a and 10b shows diffracted intensity for alternating aperture lines and vias, respectively.

FIGS. 11a and 11b illustrate how minimum features can be aligned within the grid be using transducer pairs.

FIGS. 12a-b show alternative transducer array geometries or patterns.

FIG. 13 shows a system architecture for a multiple beam laser patterning generator that uses a revolving polygon to scan the image onto the substrate.

### DETAILED DESCRIPTION

Overview

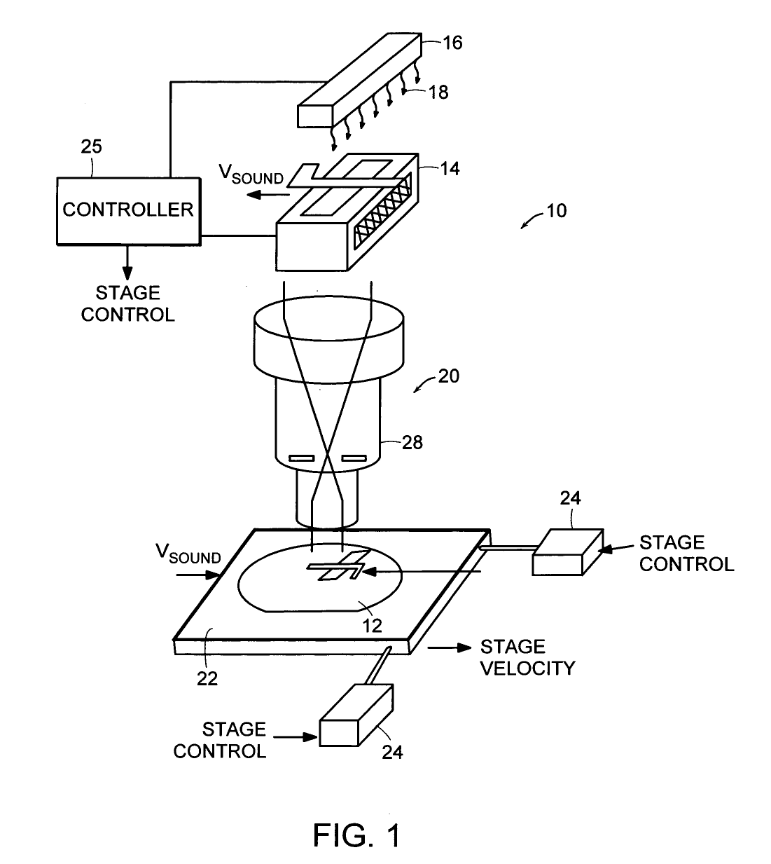

The basic structure of a laser pattern generator 10 that embodies the invention is illustrated by FIG. 1. In operation, pattern generator 10 directly writes a pattern onto photoresist that is coating the surface of a substrate 12. Typically, the pattern defines some arrangement of openings or pathways that are to be fabricated into or onto the substrate during a corresponding stage of the semiconductor fabrication process. Pattern generator 10 includes an acousto-optic modulator (AOM) 14, a light source 16 for supplying a sheet light beam 18 to AOM 14, an optical system 20, and a stage 22 which holds the substrate on which a pattern is to be written. It also includes a transport mechanism 24 for moving the substrate under optical system 20.

Light source 16 includes a laser and appropriate optics to generate the sheet (or rectangularly-shaped) beam. It employs known techniques for doing this such as using a phase grating to create a uniform distribution and using specially designed lenses to spread out the beam.

During operation, control circuitry 25 causes AOM 14 to modulate light beam 18 with the information that is to be written onto the wafer. The output of AOM 14 is a tightly packed array of modulated light beams. Optical system 20, which includes a reduction lens 28, focuses the array of modulated light beams onto substrate 12. And transport mechanism 24 moves stage 22 under optical system 20 so that the pattern can be written over some predefined area of the substrate. Transport mechanism 24 moves stage 22 at a rate that satisfies the scophony condition relative to the acoustic wave that propagates through the AOM. The scophony condition is described in greater detail below.

AOM 14 is more accurately referred to as a packed array, multi-channel AOM that employs an array of tightly packed transducers. The array of tightly packed transducers defines the locations of the beams in the array of output beams. This can be contrasted to the conventional approach in which the discrete beams of the array are generated before they are delivered to the AOM by using parallel plate beam splitters or a diffractive optical element.

Before describing the operation of the system of FIG. 1 in greater detail, it would first be useful to review how a simple one channel AOM operates and then how the packed array, multi-channel AOM is designed and operates.

Basic AOM Design

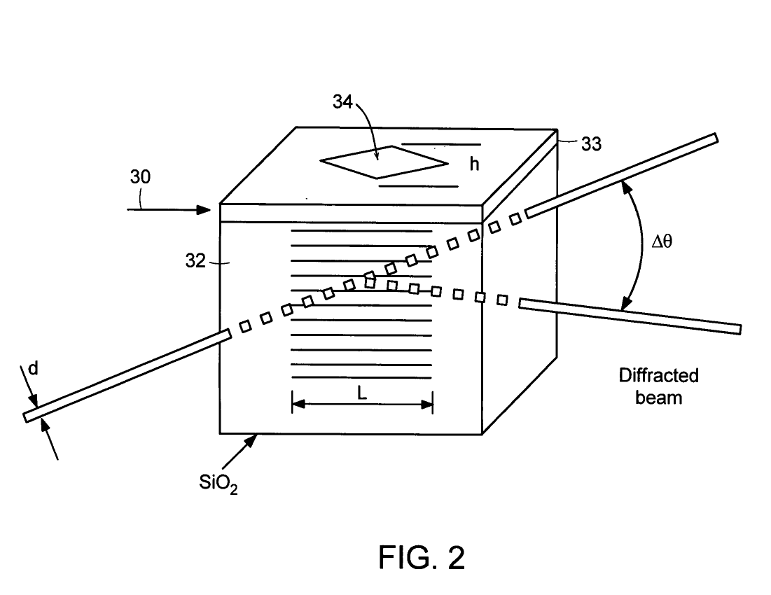

A simple one channel AOM device is illustrated in FIG. 2. It includes a lithium niobate layer 30 that is attached to a fused silica interaction medium (i.e., a substrate 32) by a conductive bonding layer 33. A transducer electrode 34 is lithographically defined on the exposed surface of the lithium niobate layer 30. An RF signal is applied between transducer electrode 34 and conductive bonding layer 33. Acoustic waves that are generated by the RF signal propagate down into substrate 32 like they were emanating from an aperture having the shape of transducer 34. The sound waves set-up a moving grating within silica substrate 32 of variations in index of refraction. This moving grating diffracts the incident light beam into an undeviated zero-order beam and a deviated first order beam. The zero-order beam is typically blocked when the device is used as a modulator.

The angle of deviation of the deviated first order beam is proportional to the RF drive frequency. Its amplitude can be varied by adjusting the voltage level of the RF drive signal. And its phase can be adjusted by altering the phase of the RF signal. A particularly important feature of the device is that phase changes and phase reversals in the acoustic field passing through the device result in corresponding phase changes and phase reversals in the diffracted light coming out of the device.

The Packed Array, Multi-Channel AOM:

A multichannel AOM is built by lithographically defining an array of separated electrodes that will be individually connected to separate RF sources. Separate beams of light are prepared and directed under each of the transducers.

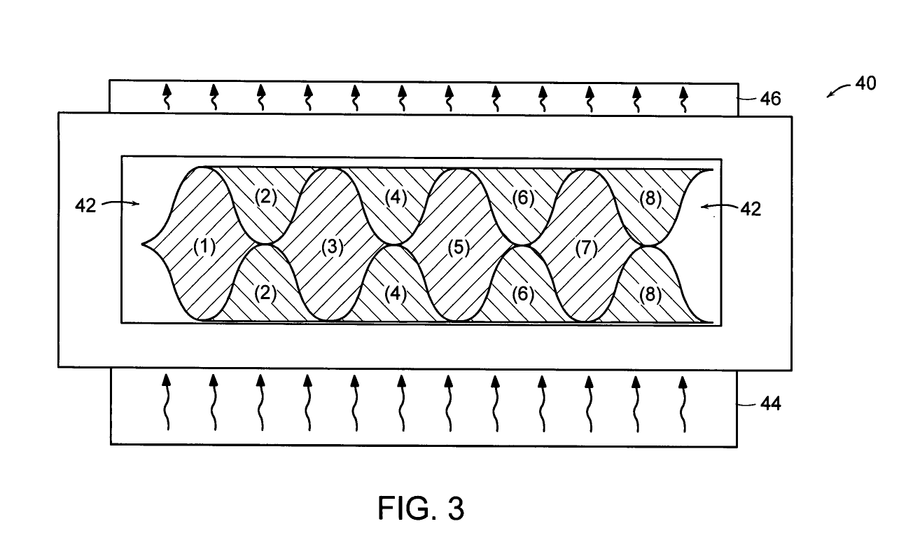

FIG. 3 illustrates the packed array transducer AOM concept. As shown, an AOM 40 array has eight transducers 42 (or four conjugate pairs). They are shaded for ease in distinguishing the two types that are shown and they are labeled by (i), wherein i=1 . . . 8. The shapes of transducers 42 are selected so that they may be closely packed or nested with little to no space separating one form the other and in such a way that they form a continuous large transducer when all are energized. In this case, the transducers 42 have an error function profile (erf):

$$erf ( z ) = \frac{2}{π} {\int }_{0}^{z} {ⅇ}^{- {t}^{2}} ⅆ t$$

But other profiles that permit a nesting or close packing n the manner shown here will work as well.

When the eight transducers are driven by RF sources, the transducers propagate acoustic waves down into the transparent optical medium. The grating that these propagating acoustic waves generate in the index of refraction of the optical medium diffracts light beam 44 into a beam 46 with intensity proportional to the RF power applied to the transducer. Light not diffracted is stopped by a beam block downstream in the optics.

Because the integrated acousto-optic effect is an integral along the path of light propagation, the diffraction from both shapes is identical. The transducers should be shaped in such a way that for an energized isolated transducer the resulting intensity profile of the diffracted light is roughly Gaussian.

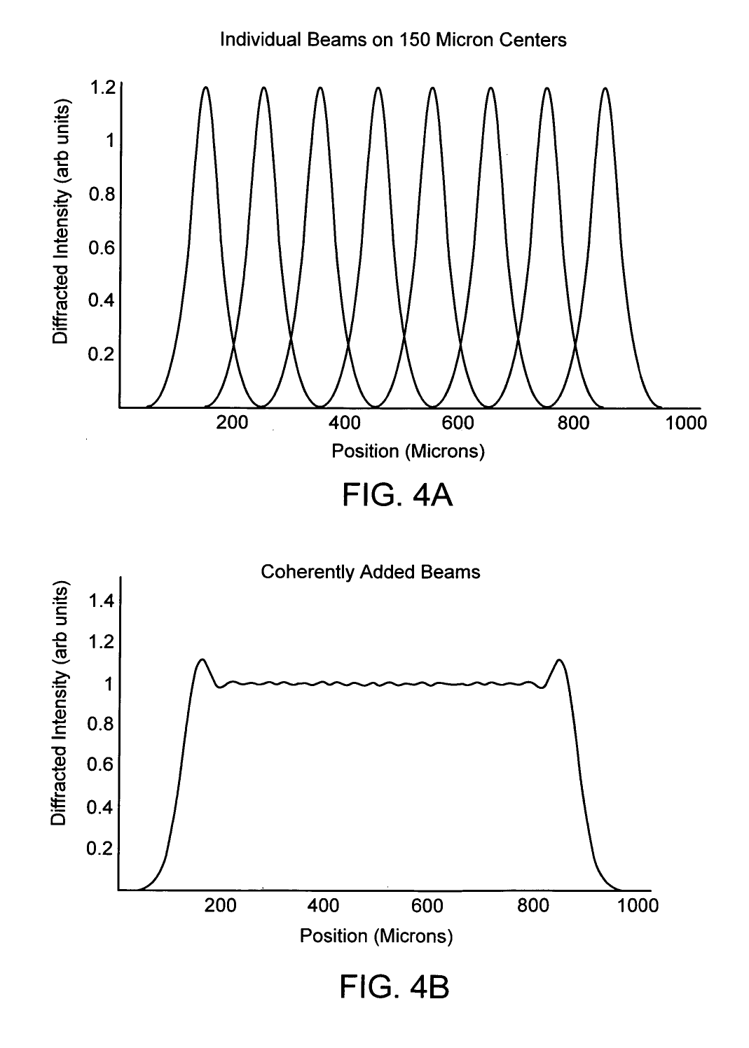

FIG. 4a shows the diffracted intensity of the output beam for individual transducers turned on. There are eight transducers. Each of them, when turned on individually produces a roughly Gaussian-shaped intensity profile emanating from that particular transducer. FIG. 4b shows the diffracted intensity for the entire array (i.e., all eight transducers) turned on. When many transducers are turned on simultaneously, the electric field is added coherently, provided the phase differences between the signals applied to the transducers are kept at zero. Turning on multiple neighboring transducers results in a steepening of the edge profile and a ringing above the normalized intensity of 1, as shown at both ends of the profile.

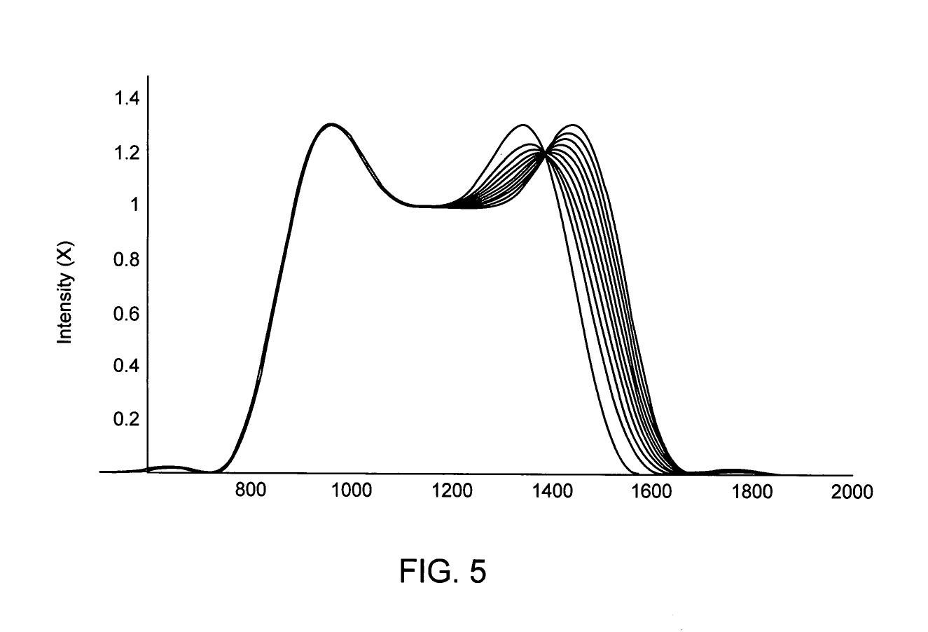

FIG. 5 shows the gray level response of the array, i.e., the response of the array when the amplitude of the signal applied to an end transducer in the array is varied. As indicated, if the intensity of the end transducer is varied continuously, the location of the edge of the intensity profile will also be varied continuously and predictably over a range. This assumes that the coherent effects are damped by the finite point spread function of the final imaging lens NA. A low NA lens smoothes out information at the edge, making it behave better. The lens acts as a filter that removes the high frequency components and thus removes squiggles. Thus, the placement of the edge of the profile can be precisely and predictably controlled, which his essential if this beam is to be used to directly write patterns with any arbitrary edge locations onto a substrate. The level of precision that is achievable is essentially a matter of how many bits one uses to specify the intensity of edge pixel.

The packed array in itself offers significant advantages in terms of steeper aerial image profiles, freedom from complicated interlacing schemes which lead to unpredictable CD uniformity errors, and problems creating a large spot array. But it becomes even more powerful when it is used to control phase behavior of the light. Changes to the phase of the RF drive frequency are translated into equivalent phase changes in the diffracted light from each transducer. Since the electric fields are combined, the same interference effects that are used in phase shift masks can be harnessed in a system that uses the packed array AOM.

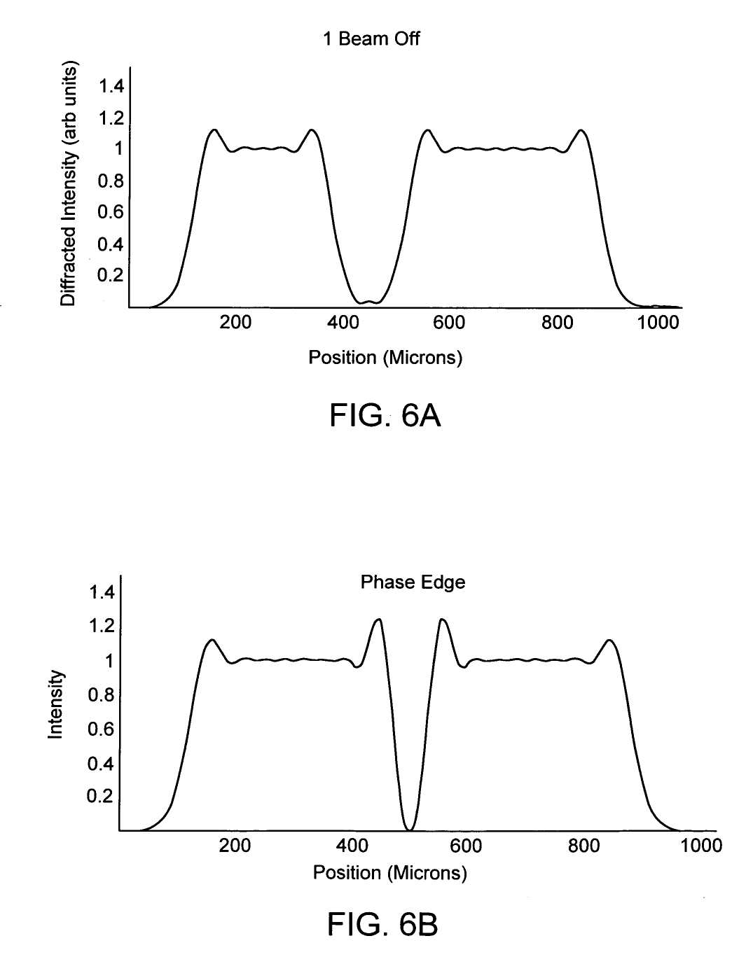

FIG. 6a shows a gap in the diffracted intensity profile that is made by turning one beam off when all transducers are driven in phase. In comparison, FIG. 6b shows the gap that is created by establishing a phase edge between two sets of transducers. In this case, the first four transducers are driven out of phase by 180° from the second four. The slope of the profile becomes much steeper at the phase edge. This is a similar effect to that achieved with alternating phase shift masks.

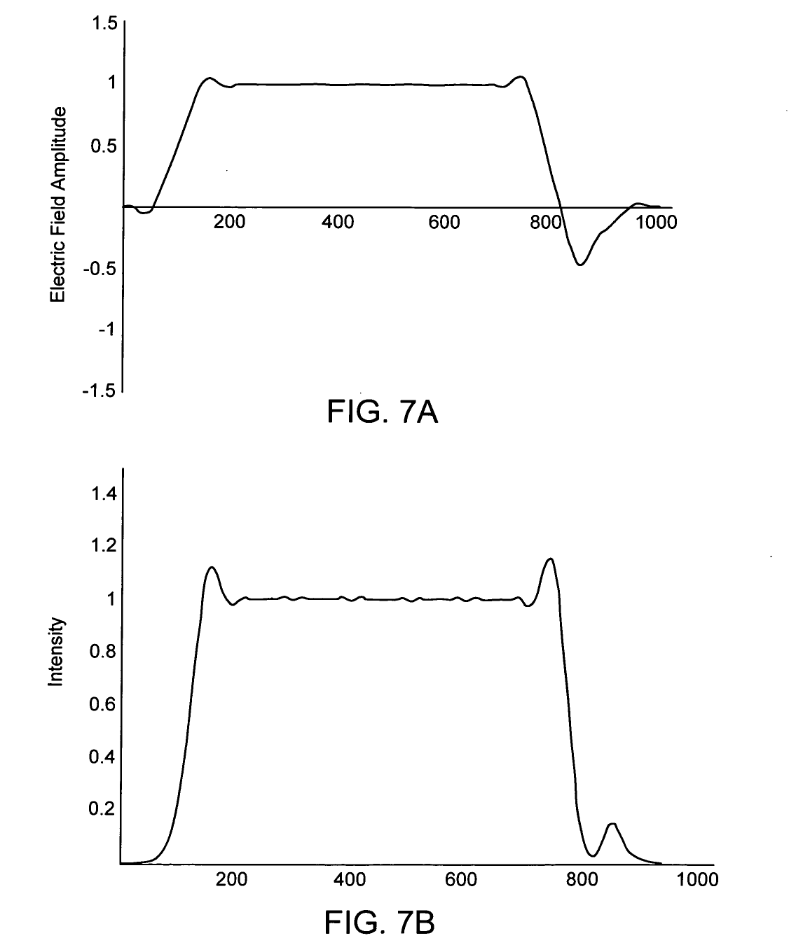

FIGS. 7a and 7b illustrate another technique that can be used to improve resolution performance with the packed array AOM. By driving an edge transducer 180° out of phase with the other transducers and with a partial intensity, the image profile becomes significantly steeper. In this case, it is the right side transducer that is driven out of phase and at the reduced amplitude. The right aerial image profile is significantly steeper than the left. This is comparable to the effects obtained with attenuating chrome phase shift masks.

The packed array AOM operates in a radically different mode, wherein the amplitude of closely spaced individually diffracted beams resulting from a uniform illumination beam are superimposed to produce a spatially distributed intensity profile at the output of the AOM. From an operational point of view, the desired intensity pattern is “synthesized” by synchronously clocking the desired pixel phase and amplitude data to produce the desired beam distribution. This differs from conventional applications of this technology in which individual transducer elements must not be modulated by adjacent channel data streams, resulting in a less densely packed multi-element structure.

Scophony Technique

The resolution enhancing phase effects described thus far act along an axis that is perpendicular to the scan direction, i.e., along the axis of the transducer array. In the described embodiment, these resolution-enhancing effects are also achieved in the scan direction by employing a well-known condition developed by the Scophony laboratories in the 1930s. In effect, the AOM cell is made deeper so that the acoustic wave propagates over a distance that represents multiple scan lines (or pixels) on the substrate. If the substrate stage is held stationary, the image of the acoustic wave that is traveling into the AOM will move on the substrate in a direction that is opposite to the direction in which it is moving through the AOM. This, of course, assumes that the imaging system inverts the image of the acoustic wave that is projected onto the substrate. By scanning the substrate in the same direction as that image moves and at the same speed as that image moves, the image of the acoustic wave that is projected onto the surface of the substrate will remain stationary on the surface of the substrate.

In short, under the scophony condition, the velocity of the acoustic waves inside the AOM, as demagnified by the projection optics, is set equal in magnitude to and opposite in direction to the scan velocity. One can think of the pattern of the diffracted light inside the AOM as being analogous to the light passing through the reticle and slit of a wafer scanner. The reticle is moving in such a way that the image on the wafer is stationary and the information inside the slit is constantly changing. If the packed array AOM cell, which is multiple scan lines deep, is illuminated by a thick sheet of light, e.g. also several scan lines deep, changes to the phase of the RF drive signal will be imaged on the substrate as stationary changes in light phase in the scan direction. Thus, in the same way that the resolution-enhancing phase effects are achieved in the direction perpendicular to the scan direction, they can also be achieved in the scan direction. That is, a phase change in the scan direction will be imaged as a phase edge. This gives one access to the entire 2D image in the sound field (i.e., both in the scan direction as well as in the direction perpendicular to the scan direction) so one can get interference effects in both directions.

New information is continually appearing in the window that is projected onto the substrate by the imaging system. For each beam (i.e., the portion of the light that is controlled by a particular transducer), the new information that is modulated onto the beam appears first on one side of the window and passes to the other side of the window at a rate that is determined by the speed of the acoustic wave in the optical medium of the AOM. This is important because it enables one to get regions of alternating phase in the scan direction and in the window at the same time. This, in turn, enables one to produce the resolution enhancing interference effects in the scan direction because to produce interference effects the electric fields that are to be interfered have to be in the window at the same time.

So, in the window that is projected onto the surface of the substrate, the light beam can exhibit changes in phase in two dimensions. In the direction of the scan, the changes in phase are produced by the modulation signal as a function of time; whereas, in the direction that is perpendicular to the scan, the changes in phase are induced by driving the transducers in the packed array by RF signals that are shifted in phase relative to each other. This technique makes it possible to impose arbitrary, on a per pixel basis, 2D control over phase and amplitude of the light beam that is projected onto the substrate. So, one can emulate all of the phase shift masks that are currently being used in the semiconductor industry.

Note that edge placement in the scan direction can be controlled either by controlling the timing of the signal driving the appropriate transducers or by using the grey level technique that was described above.

Returning to FIG. 1, the direct writing system works as follows. A continuous wave laser generates a light beam that is shaped by appropriate optics to produce the rectangularly-shaped beam. That rectangularly-shaped beam is inserted into the AOM sound field. The diffracted light from the sound field is demagnified by the reduction lens and re-imaged onto the wafer or substrate. The wafer stage travels with a velocity equal to the acoustic velocity as imaged onto the wafer. The information inside the illuminated slit at the AOM is used instead of the pattern on a mask. In this architecture, the wafer stage scans across the entire wafer before stopping, not just across one reticle field. One stripe is written and then the stage is retraced and an adjacent stripe is written. Butting errors between stripes are minimized by tapered intensity regions on both ends of the array. Multiple passes can also be used to reduce errors from many sources.

2D Acousto-Optic Imaging

The diffracted intensity or electric field of the 2D slit region (or window) inside the AOM was modeled based on the work of L. Bademian, “Parallel-channel acousto-optic modulation,” Optical Engineering, vol. 25, pp. 303-308, February 1986 and B. D. Cook, E. Cavanagh, and H. D. Dardy, “A numerical procedure for calculating the integrated acoustooptic effect,” IEEE Trans. Sonics Ultrason., vol. SU-27, pp. 202-207, July 1980. A Mathematica program was used to calculate the integrated acousto-optic effect in the slit region from 8 separate transducers. The phase of the acoustic waves (and correspondingly the light) was adjusted on a per transducer basis and could be altered along the direction of sound propagation as well. Diffracted electric fields from each of the transducers were added linearly and then squared to compute the intensity. For the final image plane calculations, the electric field was convolved with the field point spread function for a particular lens NA and then squared to compute intensity profiles at the wafer plane.

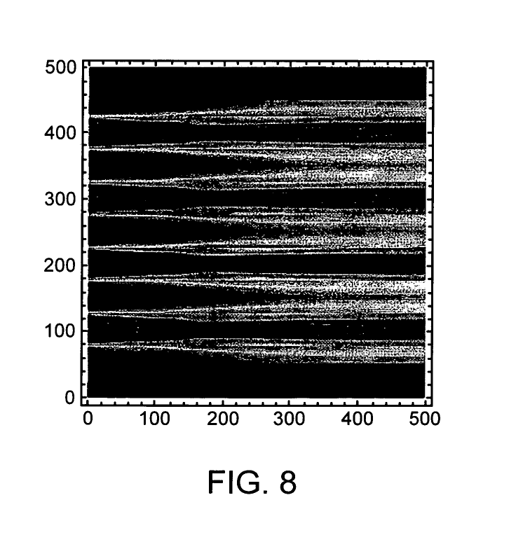

FIG. 8 shows the diffracted intensity from 4 pair of transducers at the left edge of the figure. The calculations assume error function shaped transducers as described above. The transducer pitch is 150 microns, the transducer length is 1000 microns, the sound velocity of the acoustic medium is 6 km/s corresponding to fused silica, and the sound frequency is 200 MHz. Each unit on the graph is 6 microns.

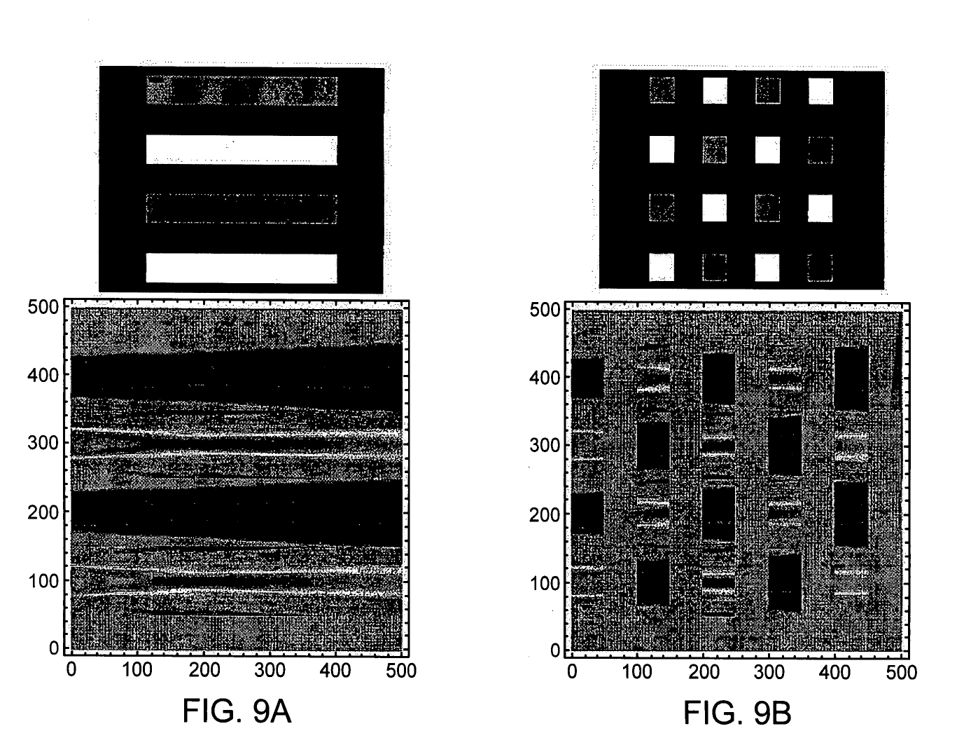

Alternating aperture PSM can be emulated by driving every other pair of apertures 180°. out of phase. FIG. 9a illustrates this type of imaging for pitched structures. FIG. 9b illustrates using this for a via array. White and grey regions have 0° and 180° phase shift, respectively.

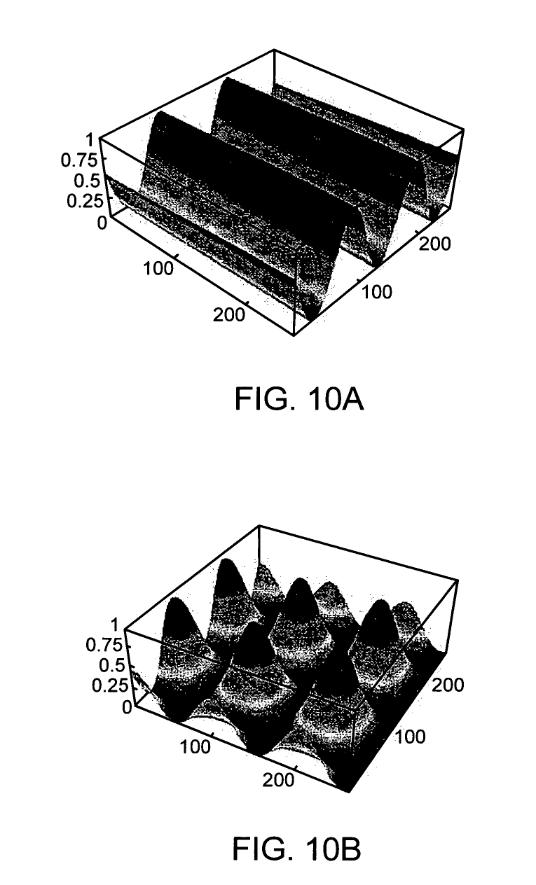

The final image intensities from these two patterns were computed by convolving the electric field with the point spread function and squaring the result. The results are shown in FIGS. 10a and 10b, which show the diffracted intensity for alternating aperture lines and vias, respectively. Peak intensities were normalized to 1. For lines, k₁=0.25 corresponding to a half pitch of 51 nm for a wavelength of 257 nm and an NA=1.25; for vias, k₁=0.4 for a half pitch of 82 nm for the same wavelength and NA.

An even more advanced phase shift concept known as vortex vias can be emulated with this acoustic phase shift technology. In this approach, an array of 0°, 90°, 180°, 270° quadrants is printed on the wafer. An intensity null is formed at the center of each quadrant. A regular array of vias can be written and unwanted vias erased on a separate trim pass.

These modeling results for line and via structures are a substantial improvement over the resolution obtained from conventional, non-phase-shifted lithography which has a limiting k₁=5 for completely coherent imaging.

As discussed above, a packed transducer array AOM can provide effective phase modulation in both axes. However, there are several system constraints that should be taken into account in the design of a system architecture that can make use of such a device. First the transducer pitch at the wafer must be small enough to make use of the phase shift imaging techniques. A pitch of ¼·λ/NA is preferable to resolve the smallest alternating aperture pitch. However, with this pitch there is no degree of freedom left for shifting the features within the grid. A smaller pitch of ⅛λ/NA gives control over edge placement.

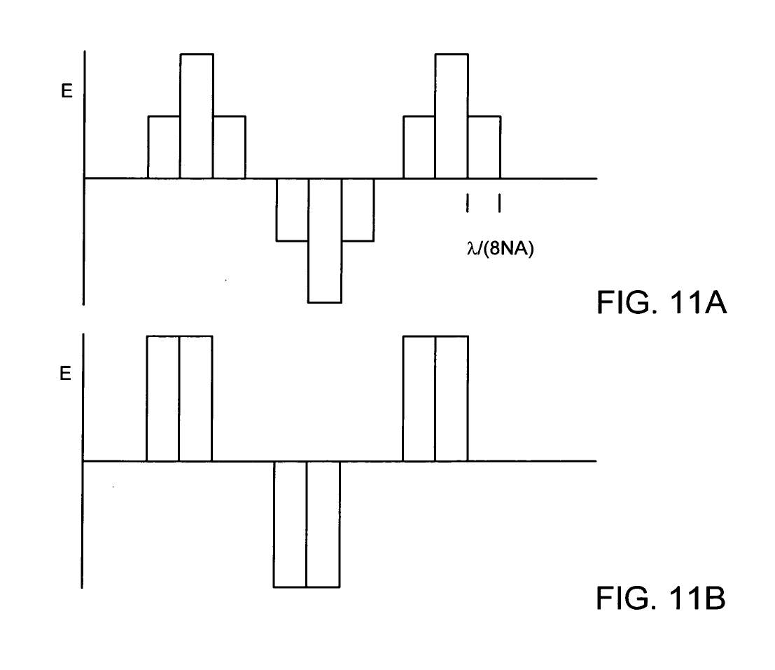

FIGS. 11a-b illustrate how minimum features can be aligned within the grid be using transducer pairs. The example interpolates by one half a grid unit; other interpolations are possible by changing electric field intensities. FIGS. 11a and 11b correspond to the alternating phase grating of FIG. 9a. By using gray levels, the electric fields in the light from each transducer can be modulated to shift the line space array by ⅛·λ/NA. Other shifts are possible by using other gray levels.

A further requirement of the system architecture is that the sound velocity as demagnified on the wafer is equal and opposite to the velocity of the AOM slit on the wafer. In other laser pattern generator architectures, fast beam-scanning has been accomplished with rotating polygonal mirrors. However, to use this new phase shift modulating technique, very high demagnification is likely to be necessary. This is because typical transducer sizes are 100 to 200 microns wide. Transducer width is limited by the wavelength of sound and packaging constraints. Demagnifications of 2,000 to 10,000 are needed to reach the λ/(8 NA) dimensions. For instance, a 198 nm wavelength system with a 0.9 NA lens requires a demagnification of 7270. These large demagnifications slow the acoustic velocity image on the wafer to speeds that can be accommodated directly by scanning stages, as illustrated in FIG. 1.

The architecture described has many advantages as a direct writer. It is capable of emulating all of the resolution enhancement printing techniques of today's modern scanners with the exception of off-axis illumination.

The simplest phase shift technique to implement is the attenuated phase shift approach. For masks this is implemented by printing on leaky chrome with a π phase shift. The attenuated phase shift approach can be easily emulated by exposing features with low intensity π phase shift on the direct writer architecture. Although only modest edge slope improvements can be achieved with this approach it has the advantage of being directly applicable to existing patterns: no modifications are required.

More benefit can be obtained by using alternating aperture phase shift (AAPS) patterning which can deliver half pitches of k₁=0.25. Applying π phase shifted regions requires careful design because of conflicts of mapping when three regions come together. There is also the possibility of creating undesired dark lines where abrupt sizable phase changes occur. Here the direct writer architecture has a clear advantage over standard scanners. Either a separate trim pass can be made, which on a scanner would require a change of mask, or multiple phase regions can be used to slowly transition between 0 and π phase shifting. This second approach can be used transparently without the cost of fabricating an expensive multi-layer mask.

Another approach that can be emulated is writing π phase shifted assist features near isolated lines or vias. As discussed above, more aggressive techniques for printing vias are also possible such as alternating aperture arrays or vortex vias.

In summary, this direct write architecture makes available basically all the resolution enhancing phase shift techniques used on scanners today. In fact, it is superior in that multiple layers do not have to be aligned during mask fabrication, multiple masks for trim exposures are unnecessary, and more levels of phase are available for advanced phase shift techniques.

There are several strategies for extending the architecture to increase throughput. The first and most straightforward is to widen the transducer array. Lens field is obviously not an issue but manufacturing constraints on the AOM will be an issue at some point. The second is to place more than one wafer on the stage in a row and write each sequentially. This amortizes turnaround overhead over multiple wafers and can reuse pixel data from the data path. The third is to provide separate writing heads for each wafer on the same stage. This allows reuse of the stage system and data path and could provide a modular approach to expansion. The fourth is to provide separate stages and optical heads for each wafer. This would still make common use of the data path but is the most expensive. The fifth is to use multiple AOMs and combine their images at some intermediate point in demagnification. A 5 wafer/hr system can be envisioned using one of these approaches.

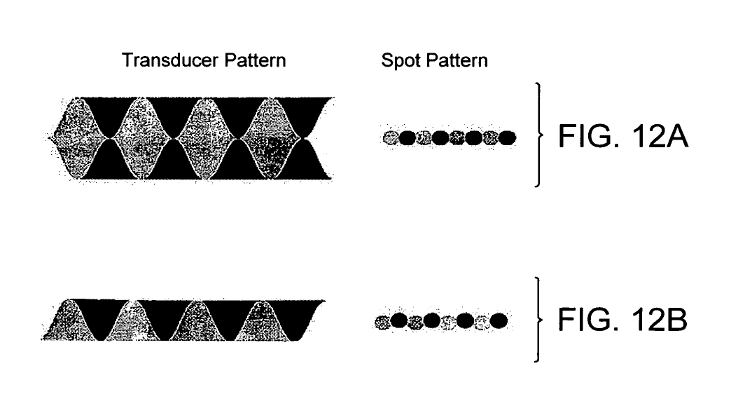

In FIGS. 12a-b, different transducer patters are shown to illustrate the underlying design principles. They are identified and referred to as Patterns A and B.

Pattern A is the pattern that was described above. The contour of each transducer is defined by the erf function. This transducer pattern fully utilizes the light of the illuminating beam by providing a 100 percent fill factor. Both the odd numbered (light shading) transducers and the even numbered (dark shading) transducers generate near Gaussian beam profiles in the transducer-to-transducer direction. The overall spot pattern is linear.

Pattern B is a variant of Pattern A. In this case, the transducers are all identical and each of the transducers is displaced and inverted from its previous neighbor by one half the width of a transducer. The displacement creates a spot displacement that is related to the lateral distance between “center of mass” of the transducers and the first order diffraction angle produced at the operating acoustic and optical wavelength. This imposes a system requirement for time delay compensation.

A cosine shape has been found to also have similar properties to the erf shaped transducer patterns.

In the implementation that was described above, it was the substrate that was moved under the optical system in order to write the pattern onto the substrate. In alternative implementations, the substrate could be held stationary while the array of modulated beams is scanned over a region of the substrate by using a rotating or oscillating mirror. Or both the substrate and the light beams could be moved simultaneously during the writing process. An example of one of these alternative approaches, namely, using a rotating polygonal mirror to scan the modulated beam is shown in Fig. will be presented later. For details about other approaches (e.g. such as using galvonometers, acousto-optic deflectors, mems devices, etc.) the reader is referred to the publicly available literature.

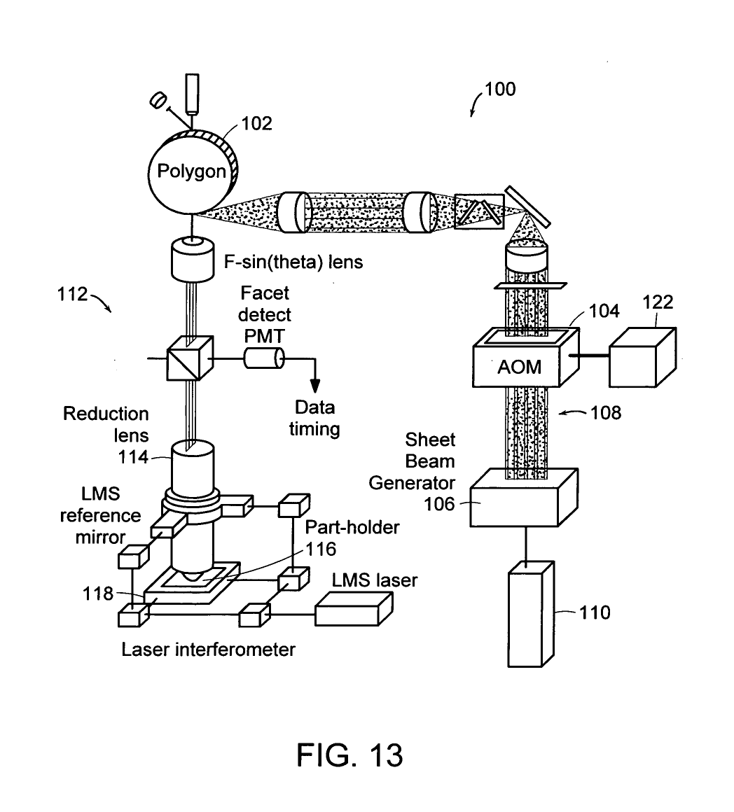

An example of a direct writing system 100 that uses a revolving polygon mirror 102 is shown in FIG. 13. The parts of system 100 that are particularly relevant to the techniques described herein are a packed array multi-channel AOM 104 and a sheet beam generator 106 that delivers a rectangularly-shaped beam 108 to AOM 104. A laser susbsystem 110 supplies light to sheet beam generator 106. The resulting sheet beam, after passing through other optical components, is focused onto the revolving polygonal mirror 102 and then projected by an imaging system 112 that includes a reduction lens 114 onto a substrate 116 being held by a substrate holder 118. The revolving polygonal mirror 102 scans the array of beams over a region of substrate 116 beneath reduction lens 114. An x-y positioning stage, precision controlled by an interferometer, is used to move substrate 116 under the lens so as to be able to separately scan multiple regions the substrate. Control circuitry 122, including a RF signal generator and modulation circuitry, supplies modulated RF signals to the array of transducers in packed array, multi-channel AOM 104. The principles of operation are as described above but with at least one exception that scanning of the image is done by the revolving polygon mirror rather than by scanning the positioning stage, as was done for the system depicted in FIG. 1.

Other embodiments are within the following claims.

What is claimed is:

1. A method of illuminating a surface of a substrate, said method comprising:
generating an array of separately modulated beams, wherein on each beam of the array of separately modulated beams, a corresponding modulation signal is imposed that propagates transversely across that beam from a bottom edge to a top edge at a velocity V;
projecting the array of separately modulated beams onto the surface of the substrate, wherein said array of beams illuminates on the surface of the substrate a two-dimensional region having a width determined by the number of beams in the array and a height that extends multiple pixels; and
causing the illuminated region to scan over the surface of the substrate in a scan direction relative to the substrate and at a scan velocity determined by V,
wherein the illumination over the illuminated varies in phase in both the scan direction and in a direction that is orthogonal to the scan direction.

2. The method of claim 1, wherein the scan velocity is selected so that a projection of the modulation signals onto the surface of the substrate remain fixed relative to the surface of the substrate.

3. The method of claim 1, wherein the scan velocity is selected to satisfy the scophony condition.

4. The method of claim 1, wherein the illumination over the two dimensional region exhibits phase changes of 180° in both the scan direction and in the orthogonal direction.

5. The method of claim 1, wherein causing the illuminated region to scan over the surface of the substrate involves moving the substrate while leaving the projected array of separately modulated beams to remain stationary.

6. The method of claim 1, wherein causing the illuminated region to scan over the surface of the substrate involves scanning the projected array of beams.

7. The method of claim 1, wherein generating the array of separately modulated beams involves generating a rectangularly-shaped beam and then passing the rectangularly-shaped beam through an acousto-optic modulator cell that includes a plurality of transducers on one end.

8. The method of claim 7, wherein generating the array of separately modulated beams also involves driving each transducers of the plurality of transducers with corresponding modulated RF signal to impose the modulation signal on that beam.

9. The method of claim 7, wherein the array of separately modulated beams is a closely packed array of separately modulated beams.

10. A system for illuminating a substrate, the system comprising:
a source for generating a sheet beam;
an acousto-optic modulator having a transducer array, said acousto-optic modulator during operation receiving the sheet beam from the source and generating an array of separately modulated beams therefrom;
an optical system for projecting the array of separately modulated beams onto a surface of the substrate to illuminate a two-dimensional region on the substrate, said two-dimensional region having a width determined by the number of transducers in the array of transducers and a height that extends multiple pixels;
a control system which during operation drives the array of transducers to impose on the array of beams a plurality of modulation signals which at the substrate propagate transversely across the illuminated region from a bottom edge of that region to a top edge of that region and at a velocity V; and
a mechanism that during operation causes the illuminated region to scan over the surface of the substrate in a scan direction relative to the substrate and at a scan velocity determined by V,
wherein the controller is programmed to cause the illumination over the illuminated region to vary in phase in both the scan direction and in a direction that is orthogonal to the scan direction.

11. The system of claim 10, wherein the scan velocity is selected so that a projection of the modulation signals onto the surface of the substrate remain fixed relative to the surface of the substrate.

12. The system of claim 10, wherein the scan velocity is selected to satisfy the scophony condition.

13. The system of claim 10, wherein the illumination over the two dimensional region exhibits phase changes of 180° in both the scan direction and in the orthogonal direction.

14. The system of claim 10, wherein the mechanism includes a substrate holder and a transport system which controls a position of the substrate holder, and wherein the controller causes the illuminated region to scan over the surface of the substrate by using the transport system to scan the substrate holder beneath the optical system, thereby moving the substrate while leaving the projected array of separately modulated beam stationary.

15. The system of claim 10, wherein the mechanism includes a revolving mirror that causes the projected array of beams to scan over surface of the substrate.

16. The system of claim 10, wherein the source for generating the sheet beam comprises a laser light source and a sheet beam generator.

17. The system of claim 16, wherein the sheet beam is a rectangularly-shaped beam.

18. The system of claim 16, wherein the controller includes a plurality of RF signal generators, each of which drives a different transducer of the array of transducers.

19. The system of claim 16, wherein the transducer array is a closely packed array of transducers.

20. The system of claim 19, wherein the transducers in the transducer array are nested with each other.

21. The system of claim 16, wherein each transducer has an outer perimeter that is defined by an erf function.

22. The system of claim 16, wherein each transducer has an outer perimeter that is defined by a cosine function.
